(19) United States
(12) Patent Application Publication
(10) Pub. No.: US 2026/0366346 A1
(43) Pub. Date: Nov. 19, 2026

(54) Lock Mechanism for Storage Box and Storage Box

(71) Applicant: Ningbo Meiqi Tool Co., Ltd., Ninghai County, Zhejiang (CN)

(72) Inventor: Lizhong You, Ningbo (CN)

(21) Appl. No.: 19/136,497

(22) PCT Filed: Mar. 25, 2024
(86) PCT No.: PCT/CN2024/083486

§ 371 Date: Jun. 6, 2025

(30) Foreign Application Priority Data
May 26, 2023 (CN) 202310618519.5

(51) Int. Cl. E05C 3/30; B65D 43/16; B65D 55/14

(52) U.S. Cl. CPC E05C 3/30; B65D 43/16; B65D 55/14; B65D 2543/00101; B65D 2555/02

(57) ABSTRACT

A latching mechanism for a case comprises a latching main body being rotatably connected to a sidewall of the case; and an auxiliary latching unit connected to the latching main body and being rotatable with the latching main body relative to the case. The auxiliary latching unit is disposed at a back of the latching main body. When the latching main body is in the first locking state, the auxiliary latching unit locks to the locking engagement part, the auxiliary latching unit has a trigger portion which is capable of driving the auxiliary latching unit to detach from the locking engagement part under an external force. The latching mechanism allows for convenient manual unlocking by operators while being resistant to accidental unlocking caused by external pressure.

### TECHNICAL FIELD OF THE INVENTION

The present invention relates to a technical field of cases, in particular to a latching mechanism for locking two parts of a case of which one part can be covered or opened relative to the other part, or locking two stacked cases together, and a case using the latching mechanism.

### BACKGROUND OF THE INVENTION

Cases, such as toolboxes, storage cases, and medicine boxes, generally consist of a case body and a lid capable of covering the case body. The lid is hinged to the case body on one side of the case body and connected on the opposite side by a latching mechanism to prevent the lid from being easily opened. Similarly, two stacked cases can also be locked together by using a latching mechanism for convenient transportation and storage.

Upon examination, a U.S. Pat. No. 6,102,455B (patent No.: US9,034,6197) discloses a container, comprising a first container portion that serves as a cover and a mating second container portion that serves as a base or main body; two latching members for releasably locking the first container portion to the second container portion; wherein, the two latch members are disposed on the first container portion, and a pair of locking engagement parts which are integrated formed with the second container portion are disposed on the second container portion; each latch member on the first container portion comprises a locking tab extending inward from a latching bar to a mounting bar for interlocking engagement with a locking engagement part. However, this latching mechanism has certain drawbacks. Since the latch members are pivotable members that are capable of rotating relative to the container, a certain preload force exists between an engagement of the latch members and the locking engagement parts to ensure a secure locking. Locking or unlocking operation requires applying force in a direction perpendicular (that is, forward or backward) to sidewalls of the lid or base so as to overcome the friction between the latch members and the locking engagement parts. This makes the locking and unlocking operations relatively laborious. Moreover, wear and deformation at engagement points between the latch members and the locking engagement parts occurs after prolonged time for use, eventually causing locking failures and significantly reducing the product's service life.

Another U.S. Pat. No. 6,527,309B (patent No.: US95743101) disclosed a more labor-saving and user-friendly latching device for a container, the container comprising a first half-portion and a second half-portion which can be releasably connected to each other through an operation of the latching device. The latching device is rotatable about a latch rotation axis L between a locking position and an unlocking position of the latching device, and when rotated to be in the locking position, the latching device locks to a stop boss formed on the container. Specifically, the latching device comprises a housing and a latch button disposed on the housing. The housing has a rectangular opening on its outer surface where the latch button is located. An outer wall of the latch button is flush with an outer wall of the housing. The latch button is rotatably connected to the housing and is biased to be in a locked position by a spring. A stopper that limits a rotational movement of the latch button when a release button is pressed during operation is disposed on the housing of the latching device. During the locking operation, the latching device rotates downward (rotates to be in the locking position) to resist a flange against a locking arm of the latch button, making the locking arm momentarily pivot over the flange before locking into place. For unlocking, the operator can simply press the latch button to detach it from the flange and then rotate the latching device upward for unlocking.

However, the latching device disclosed in the above-stated U.S. Pat. No. 6,527,309B still has some drawbacks. Firstly, the rectangular opening on the housing that accommodates the latch button runs across the housing in a front-to-rear direction, which means a triggering portion of the latch button is fully exposed on a front side of the housing, leaving the latch button susceptible to unintended pressure from external objects. This may cause accidental unlocking of the container, especially during handling or transportation of the container. Secondly, the opening (rectangular opening) on the housing, on one side, weakens the structural strength of the housing, making it prone to deformation or damage when the operator pushes or pulls the latching device during locking or unlocking operation of the container, and on the other side, opening on the outer wall of the housing and embedding the latch button within an opening affects the latch device's aesthetic appeal to a certain extent. Additionally, dirt and dust can accumulate in gaps between the latch button and the housing's opening.

Therefore, existing latching mechanisms for cases still require further improvement.

### SUMMARY OF THE INVENTION

It is a first object of the present invention to provide a latching mechanism for a case, which allows for convenient manual operation for unlocking by operators while being resistant to accidental unlocking caused by external pressure.

It is a second object of the present invention to provide a latching mechanism for a case, which eliminates the need for having holes on a latching main body, thereby ensuring structural strength and preventing deformation of the latching mechanism.

It is a third object of the present invention to provide a latching mechanism for a case, which enhances overall aesthetics due to no need for having holes on a latching main body.

It is a fourth object of the present invention to provide a case using the latching mechanism. The case with the latching mechanism has a reliability of locking, can be prevented from accidental unlocking caused by external pressure. Since no holes are required on a latching main body, the structural strength of the latching mechanism is ensured, the deformation is prevented, and the overall aesthetic appeal is improved.

For achieving any one of the first, second or third objects, the latching mechanism for a case, being used to lock with a locking engagement part connected to the case, comprises:
a latching main body being rotatably connected to a sidewall of the case around a first axis extending in a horizontal direction;
an auxiliary latching unit connected to the latching main body and being rotatable with the latching main body relative to the case; when the latching main body is in the first locking state, the auxiliary latching unit locks to the locking engagement part, the auxiliary latching unit has a trigger portion which is capable of driving the auxiliary latching unit to detach from the locking engagement part under an external force;
the auxiliary latching unit is disposed at a back of the latching main body and is substantially invisible seen from the front of the case under the cover of the latching main body; when the latching main body is in the first locking state, an operating space is defined on the latching main body or between the latching main body and the component which has the locking engagement part, the operating space allows an operator's finger to reach into the operating space and operate the trigger portion for unlocking the auxiliary latching unit from the locking engagement part.

In order to better conform to the operator's operation habits for unlocking, preferably, the latching main body has a connecting portion being connected to the case, and an operating part being located at an end of the latching main body away from the connecting portion; when the latching main body is in the first locking state, the operating space is defined between the operating part of the latching main body and the component which has the locking engagement part, and at least a part of the auxiliary latching unit is located in the operating space. By arranging the operating space adjacent to the operating part of the latching main body, operators can not only press the triggering portion of the auxiliary latching unit for unlocking but also can more conveniently operate the operating part of the latching main body at the same location to unlock the latching main body from the latching engagement part. This ensures the convenience of the whole unlocking operation for the latching mechanism. It can be thought that the operating space may also be a cavity directly formed on the independent latching main body.

To effectively prevent the auxiliary latching unit from being touched by external objects, preferably, the entire auxiliary latching unit is located in the operating space.

Generally, the auxiliary latching unit may be disposed on the latching main body and is capable of sliding in a linearly manner relative to the latching main body. That is, when the latching main body is in the first locking state, the auxiliary latching unit slides linearly to latch to or detach from the locking engagement part. However, to enhance the convenience of the locking and unlocking operations of the auxiliary latching unit, preferably, the auxiliary latching unit is rotatably connected to the latching main body around a second axis which is parallel to the first axis; when changing positions in a rotation relative to the latching main body, the auxiliary latching unit is in a second locking state when locking the locking engagement part or in a second unlocking state when detachably unlocking the locking engagement part.

As an improvement, the auxiliary latching unit comprises the trigger portion extending from a portion where the second axis located of the auxiliary latching unit towards the operating part of the latching main body and a limit stop extending from the portion where the second axis located of the auxiliary latching unit towards the connecting portion of the latching main body; when being subjected to an external force, the trigger portion is moved towards the latching main body so that the trigger portion unlocks the locking engagement part. After pressing the trigger portion of the auxiliary latching unit toward a position where the latching main body is located for unlocking, operators can lift the latching main body for unlocking, ensuring a more convenient and efficient unlocking operation of the latching mechanism.

In order to prevent the auxiliary latching unit from being easily detached from the locking engagement part and ensure the locking reliability of the latching mechanism, preferably, the latching mechanism further comprises an elastic member acting on the auxiliary latching unit; wherein the elastic member urges the trigger portion of the auxiliary latching unit away from the latching main body;
the limit stop of the auxiliary latching unit is capable of resisting against an inner side wall of the latching main body to make the movement of the trigger portion of the auxiliary latching unit in a certain range.

The elastic member may be various members in the prior art, for example, elastic elements such as compression springs, torsion springs and reeds. However, in order to better cooperate with the auxiliary latching unit, preferably, a side wall of the latching main body in the first locking state facing the locking engagement part of the case is defined as the inner side wall of the latching main body; the elastic member is a spring and the spring resists between the trigger portion of the auxiliary latching unit and the inner side wall of the latching main body.

In order to firmly fix the spring between the auxiliary latching unit and the latching main body, preventing the spring from being falling off, preferably, the spring has a first end and a second end, the first end of the spring is sleeved onto a first position column, the first position column is disposed on the inner side wall of the latching main body, the trigger portion has a side wall facing the inner side wall of the latching main body, a second position column is disposed on the side wall of the trigger portion of the auxiliary latching unit and the second end of the spring is sleeved on the second position column.

In order to ensure a locking fastness of the latching mechanism in a locking state and a labor-saving unlocking operation of the latching mechanism, preferably, the locking engagement part comprises a first part with a horizontal surface and a second part with a vertical surface, the first part and the second part are arranged adjacent to each other; the latching main body has a side surface facing the locking engagement part, a first lock part extending from the side surface of the latching main body to the locking engagement part latches to the first part of the locking engagement part to limit the first part along a vertical direction, the auxiliary latching unit has a side surface facing the locking engagement part, a second lock part extending from the side surface of the auxiliary latching unit to the locking engagement part latches to the second part of the locking engagement part to limit the second part along a front to rear direction.

When the latching mechanism engages with the locking engagement part, the latching main body latches to the first part of the locking engagement part along the vertical direction, while the auxiliary latching unit latches to the second part of the locking engagement part along the front to rear direction. As a result, the entire latching mechanism cannot be easily deflected for opening. Particularly, since the auxiliary latching unit is disposed on an inner side of the latching main body, the auxiliary latching unit will not be unlocked from the latching engagement part due to accidental contacts. When the latching mechanism needs to be unlocked from the latching engagement part, the auxiliary latching unit is first pressed to make itself detach from the second part of the locking engagement part, thereby releasing the auxiliary latching unit from being limited on the second part of the locking engagement part along a horizontal direction. Then, since the latching main body limits the first part of the latching engagement part only along the vertical direction, the latching main body can be easily deflected outward to open. Finally, the entire latching mechanism detaches from the locking engagement part. A more labor-saving unlocking operation is ensured, which aligns with operators' habits for unlocking, providing a better user experience.

In order to make the latching main body latches to the locking engagement part to limit the locking engagement part only along the vertical direction, rather than along the horizontal direction which makes the latching main body suffer a greater resistance during its deflection for opening, preferably, at least a surface of the first lock part of the latching main body which latches to the first part of the locking engagement part is a plane; when the latching main body is in the first locking state, the surface of the first lock part of the latching main body extends horizontally;
in order to make the auxiliary latching unit latches to the locking engagement part to limit the locking engagement part along the horizontal direction, the second lock part of the auxiliary latching unit has an end away from the auxiliary latching unit, at least the end of the second lock part is constructed with a hook-shaped part with a hook-shaped cross section;
when the auxiliary latching unit latches to the locking engagement part along with a rotation of the latching main body, the hook-shaped part of the auxiliary latching unit passes a bottom of the second part of the locking engagement part to rest in a side of the second part of the locking engagement part away from the latching main body, so that the auxiliary latching unit is locked in place to the locking engagement part.

In order to mount the auxiliary latching unit on the latching main body and simplify the structure of the latching mechanism, preferably, the latching mechanism comprises two first lock parts which are symmetrically arranged in a lateral direction, the auxiliary latching unit is rotatably connected to two opposite sides of the two first lock parts, a recess for accommodating the auxiliary latching unit is defined between the two first lock parts.

In order to rotatably connect the auxiliary latching unit to the latching main body, preferably, the auxiliary latching unit has a transverse hollow first shaft hole, the auxiliary latching unit is rotatably connected to two opposite sides of the two first lock parts by a first pin shaft running through the first shaft hole.

In order to ensure the structural strength of the auxiliary latching unit, preferably, a first support rib and a second support rib which both extend toward the locking engagement part are disposed on the trigger portion of the auxiliary latching unit, the first support rib and the second support rib are respectively connected to left and right sides of the second lock part of the auxiliary latching unit.

In order to ensure the overall aesthetic appeal of the latching main body, preferably, a side wall of the latching main body in the first locking state away from the locking engagement part is defined as an outer side wall of the latching main body, the outer side wall of the latching main body is constructed as a complete plane or curved structure.

For achieving the fourth object, a case, comprising a case body having a top opening and a lid which can be opened or closed is disposed on a top opening of the case body;
wherein, the locking engagement part is connected to one of the case body or the lid, the latching mechanism is connected to the other of the case body and the lid; when the lid is closed on the top opening of the case body, the lid is locked to the case body by the latching mechanism locking to the locking engagement part.

In order to match with the latching main body and the auxiliary latching unit, preferably, the case body comprises a bottom wall and a first side wall vertically extending upward from a periphery of the bottom wall, the case body has a flange protruding from the first side wall of the case body to the outside, the flange comprises a flange body and a first stopper extending downward from a bottom of the flange body, a gap exists between the first stopper and the first side wall of the case body; the lid comprises a top wall and a second side wall vertically extending downward from a periphery of the top wall, the latching mechanism is vertically disposed at the second side wall of the lid and opposite the flange at the first side wall of the case body; when the latching main body of the latching mechanism is in the first locking state, a part of the latching main body is locked to the bottom of the flange body; when the auxiliary latching unit is locked, a part of the auxiliary latching unit is limited at a side of the first stopper facing towards the case body, the flange is defined as the locking engagement part. A bottom of the flange body is constructed as the first part of the locking engagement part, and the first stopper is constructed as the second part of the locking engagement part.

In order to ensure an improved locking fastness of the latching mechanism, preferably, a part where the first stopper of the flange is connected to the flange body is located at a middle position of the flange body in a lateral direction; when in the first locking state, the latching main body is locked to the bottom of the flange body on left and right sides of the first stopper.

To ensure that the auxiliary latching unit can smoothly bypass the first stopper on the flange to be limited inside the first stopper during its downward deflection with the latching main body, preferably, the first stopper of the flange has an outer side wall, at least a lower portion of the outer side wall is constructed as a guiding slope that vertically inclines downward towards an inside of the case body.

In order to protect the latching mechanism (especially the latching main body) in a locking state, preventing from damage by external objects touching a side of the latching mechanism, preferably, two first ribs each extending vertically and protruding outwardly are disposed at the first side wall of the case body corresponding to the left and right sides of the flange, the latching main body in the first locking state is arranged between the two first ribs.

In order to ensure a more stable deflection of the latching main body, preferably, left and right sides of the latching main body respectively attach to opposite side walls of the two first ribs.

In order to ensure a strength of the two first ribs so as to prevent from deformation easily, preferably, the first side wall of the case body has a first edge protruding outward relative to the first side wall formed at a periphery of the top opening on the first side wall, the first edge seals with a bottom periphery of the second side wall of the lid, a top of the each first rib of the case body is connected to the first edge of the case body.

Compared with the prior art, the latching mechanism of the present invention has the following advantages. Firstly, the auxiliary latching unit is disposed at the back of the latching main body, which means the auxiliary latching unit is hidden at an inner side of the latching main body, preventing unintended unlocking by accidental contact or pressure from external objects during handling or transportation. This significantly reduces the risk of the case being opened due to accidental triggering of the auxiliary latching unit. At the same time, the operating space is defined on the latching main body or between the latching main body and the component which has the locking engagement part. The operating space allows an operator's finger to reach into the operating space and operate the trigger portion for unlocking the auxiliary latching unit to the locking engagement part. Thus, an operator-friendly operation for unlocking is ensured. Secondly, arranging the auxiliary latching unit on the back of the latching main body eliminates the need to have holes on the latching main body for accommodating the auxiliary latching unit. This ensures the structural strength of the latching main body, preventing the latching main body from deformation or damage. Additionally, an outer surface of the latching body is integral as a whole, enhancing its aesthetic appeal and making it less prone to dust or dirt accumulation.

### BRIEF DESCRIPTION OF THE DRAWINGS

FIG. 1 is a first perspective view of a case according to an embodiment of the present invention;

FIG. 2 is a vertical sectional view of the case according to the embodiment of the present invention;

FIG. 3 is an enlarged view of Part-A in FIG. 2;

FIG. 4 is a second perspective view of the case seen from the bottom according to the embodiment of the present invention (when a latching mechanism is in an unlocking state);

FIG. 5 is an enlarged view of Part-B in FIG. 4;

FIG. 6 is a third perspective view of the case according to the embodiment of the present invention (when a lid is open relative to a case body);

FIG. 7 is an enlarged view of Part-C in FIG. 6;

FIG. 8 is a perspective view of the latching mechanism according to the embodiment of the present invention;

FIG. 9 is an exploded view of the latching mechanism according to the embodiment of the present invention;

FIG. 10 is a perspective view of an auxiliary latching unit of the latching mechanism according to the embodiment of the present invention;

FIG. 11 is another perspective view of the auxiliary latching unit of the latching mechanism according to the embodiment of the present invention.

### DETAILED DESCRIPTION OF THE INVENTION

The present invention will be further described below in detail by embodiments with reference to the accompanying drawings.

It should be noted that in the description and claims of the present invention, the terms used to indicate direction, such as “front, back”, “up, down”, “left, right”, “side, top, bottom”, etc. are used to describe structures and elements of the present invention for better explanation. And these terms used here are based on an orientation in the accompanying drawings. Since the embodiments disclosed by the present invention can be set in different directions, these terms indicating directions are only used as explanations and should not be used as restrictions. For example, the verbs “up”, “down” should not be limited to the direction opposite or consistent with the gravity.

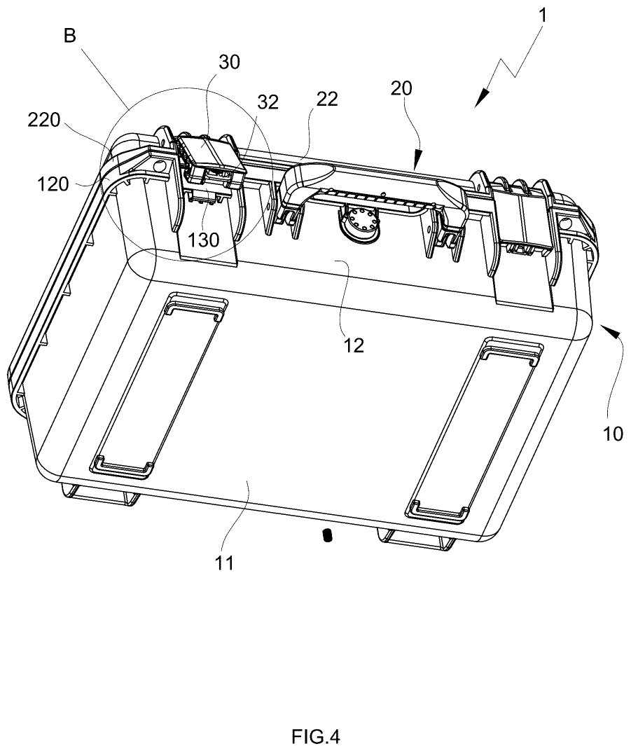

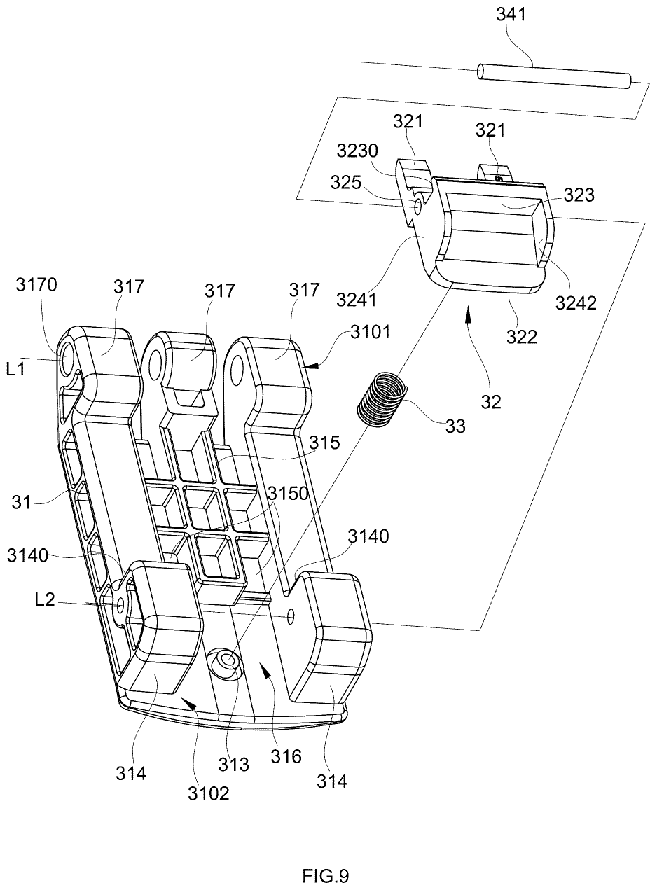

FIGS. 1-11 show a preferred embodiment of a case of the present invention. The case comprises a case body 10, a lid 20, two pairs of locking engagement parts 130 and latching mechanisms 30 connected to the case body 10 and the lid 20.

Herein, the case body 10 comprises a bottom wall 11 and a first side wall 12 vertically extending upward from a periphery of the bottom wall 11. A top opening 10a is defined at an upper portion of the first side wall 12. The lid 20 comprises a top wall 21 and a second side wall 22 vertically extending downward from a periphery of the top wall 21. A bottom opening 20a is defined at a lower portion of the second side wall 22. The first side wall 12 of the case body 10 has a first edge 120 protruding outward relative to the first side wall 12 formed at a periphery of the top opening 10a on the first side wall 12. Correspondingly, the second side wall 22 of the lid 20 has a second edge 220 protruding outward relative to the second side wall 22 formed at a periphery of the bottom opening 20a on the second side wall 22. When the lid 20 covers the case body 10, the second edge 220 of the lid 20 seals with the first edge 120 of the case body 10 in a vertical direction. Herein, the first edge 120 and the second edge 220 are engaged through a protrusion-and-groove mating structure so as to enhance the sealing effect.

The second side wall 22 of the lid 20 is rotatably connected to the first side wall 12 of the case body 10 at a rear side of the case via a hinge 40, allowing the lid 20 to cover or uncover the top opening 10a of the case body 10 by a rotation of the hinge 40. To prevent the lid 20 from being easily opened after covering the case body 10, the case body 10 and the lid 20 are further connected together via two pairs of locking engagement parts 130 and latching mechanisms 30.

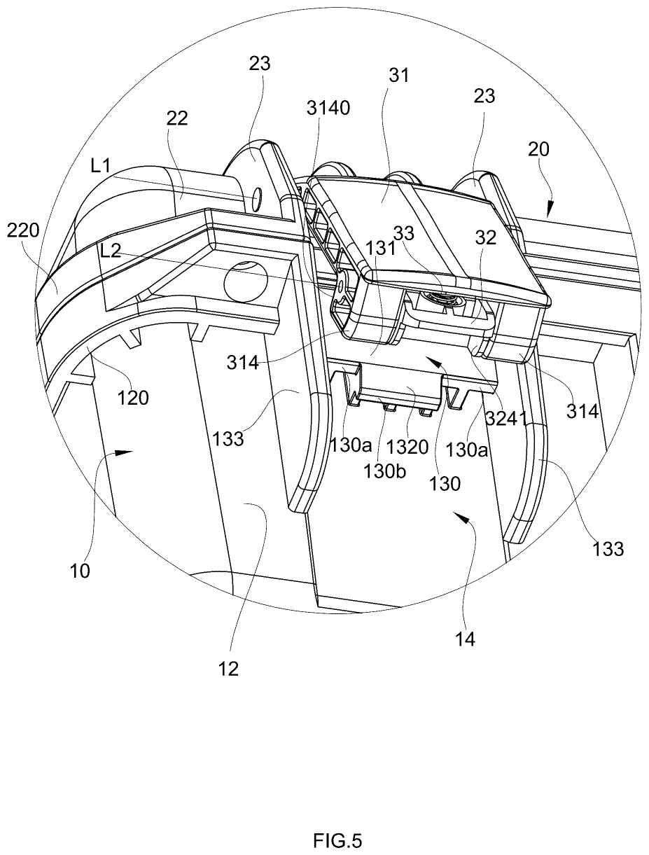

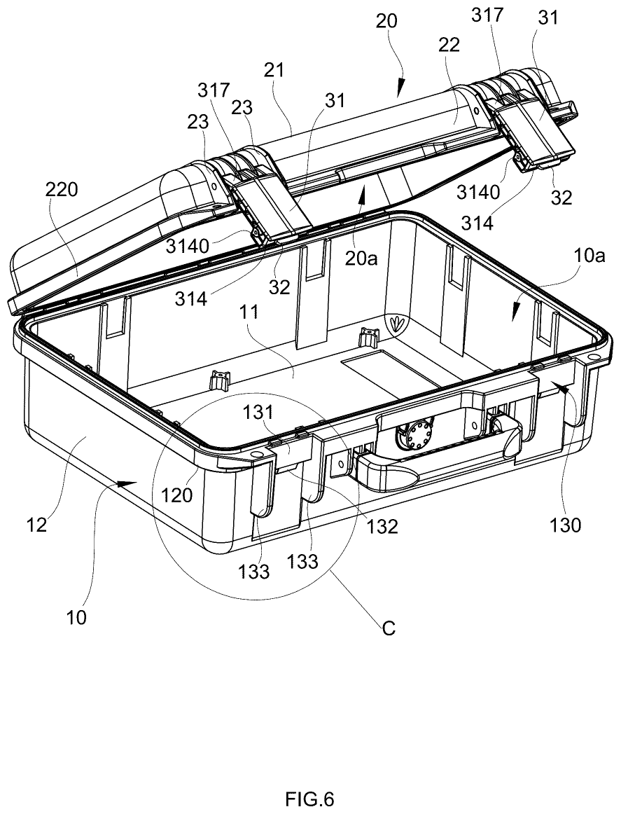

Specifically, the two locking engagement parts 130 are connected to one of the case body 10 or the lid 20, and the two latching mechanisms 30 are correspondingly connected to the other of the case body 10 and the lid 20. When the lid 20 covers the case body 10, the lid 20 locks to the case body 10 by the two locking engagement parts 130 latching to the corresponding two latching mechanisms 30. In this embodiment, the two pairs of locking engagement parts 130 and latching mechanisms 30 are disposed symmetrically on left and right sides of a handle of the case, respectively. Of course, while ensuring sufficient locking reliability, a single pair of locking engagement part 130 and locking mechanism 30 may also be used for a case. As shown in FIGS. 5-6, in this embodiment, the two locking engagement parts 130 are disposed at the first side wall 12 of the case body 10, and the two latching mechanisms are disposed at the second side wall 22 of the lid 20. The two locking engagement parts 130 correspond to the two latching mechanisms 30 in a vertical direction. The hinge 40 for connecting the case body 10 and the lid 20 is disposed at the rear side of the case, while the two locking engagement parts 130 on the case body 10 and the two latching mechanisms 30 on the lid 20 are arranged at a front side of the case.

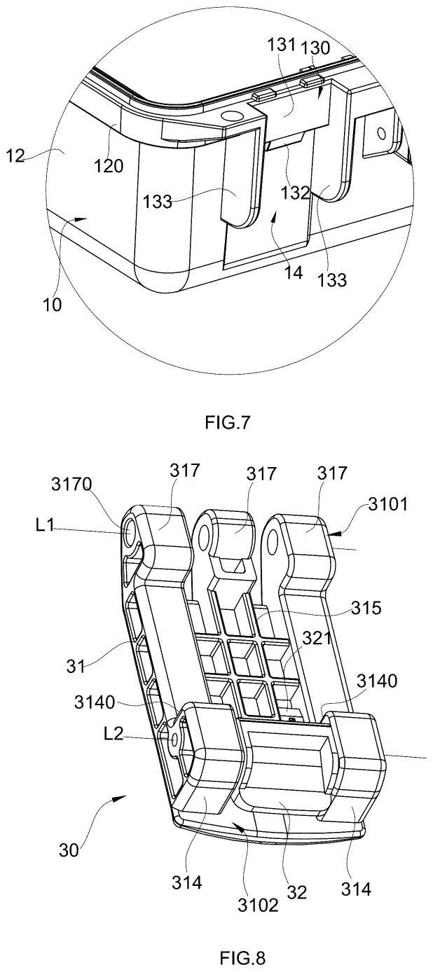

As shown in FIG. 7, in this embodiment, the case body 10 has two flanges protruding from a front side wall of the case to the outside formed adjacent to the first edge 120 of the case body 10. Each flange is defined as the locking engagement part 130. Specifically, each flange 130 (that is, the locking engagement part 130) comprises a flange body 131 and a first stopper 132 extending downward from a bottom of the flange body 131. Herein, the first stopper 132 is connected to a middle portion of the bottom of the flange body 131 in a left-to-right direction. A gap exists between the first stopper 132 and the front side wall of the case body 10. The first stopper 132 has a front side wall which is defined as an inclined guiding surface 1320 sloping backward from top to bottom. The first stopper 132 on the flange 130 is constructed as a second part 130b of the locking engagement part 130.

As shown in FIG. 5, the flange body 131 has a horizontally extending plane at the bottom corresponding to a region of left and right sides of the first stopper 132. This plane is constructed as a first part 130a of the locking engagement part 130.

Continuing to refer to FIG. 5, two first ribs 133 each extending vertically and protruding outwardly are disposed at the first side wall 12 of the case body 10 corresponding to the left and right sides of the flange 130. Top portions of the two first ribs 133 are connected to the first edge 120 of the case body 10, and opposite inner side walls of the two first ribs 133 respectively attach to the left and right sides of the flange body 131. Herein, the two first ribs 133, first edge 120, and flange 130 may be integrally molded with the first side wall 12 of the case body 10. On the other hand, as shown in FIG. 7, a recessed area 14 is defined between the two first ribs 133 of the case body 10. In this embodiment, each first rib 133 protrudes forward from the first side wall 12 of the case body 10 to a greater extent than the flange 130, so that the latching mechanism 30 in a locking state can be entirely accommodated within the recessed area 14 which is defined by the two first ribs 133, thereby reducing the risk of damage from external impacts.

In this embodiment, the case body 10 and lid 20 of the case are connected by two sets of locking mechanisms 30 latching to the corresponding locking engagement parts 130. As shown in FIGS. 8-11, each locking mechanism 30 consists of a latching main body 31, an auxiliary latching unit 32 and an elastic member 33.

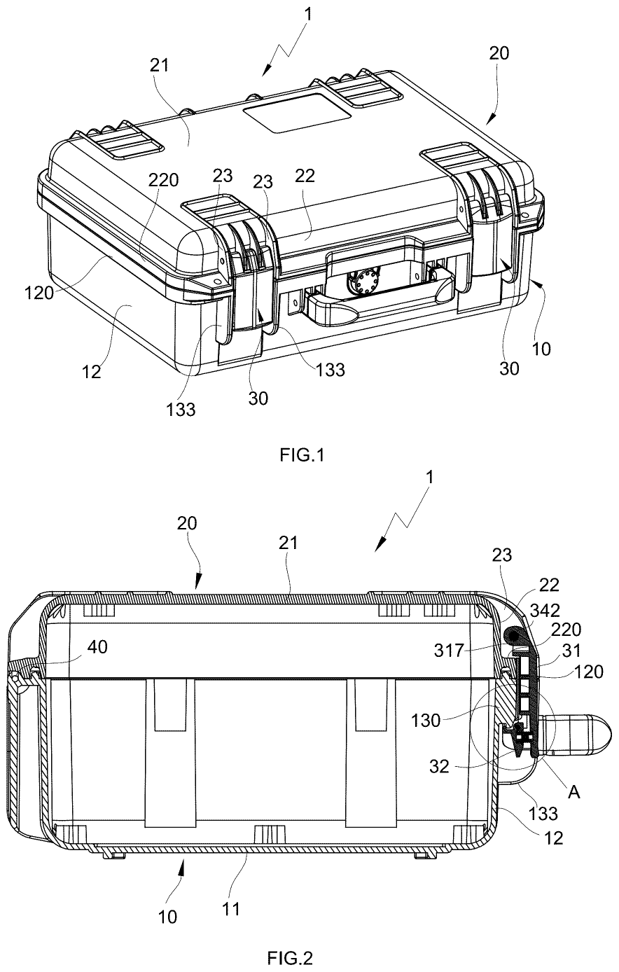

The latching main body 31 in this embodiment is integrally plate-shaped. The latching main body 31 in a locking state is illustrated in FIG. 7, we can see that the latching main body 31 has an inner side wall 311 facing towards the flange 130 and an outer side wall 312 away from the flange 130. To ensure aesthetic integrity, the outer side wall 312 of the latching main body 31 is constructed as a complete plane or curved structure. As shown in FIG. 2, the latching main body 31 has three connecting ribs 317 (serving as connection portions 3101 of the latching main body 31) distributed alternatively at a top of the latching main body 31 in a left-to-right direction. The three inclined connecting ribs 317 extend rearward from bottom to top. Each connecting rib 317 has a laterally penetrating second shaft hole 3170 at a top of the connecting rib 317. The latching main body 31 is rotatably connected to a front side wall of the lid 20 via a second pin 342 which runs through the three second shaft holes 3170 of the connecting ribs 317. As shown in FIG. 5, four second ribs 23 each extending vertically and protruding outwardly are disposed at the front side wall of the lid 20. The four second ribs 23 are laterally distributed at intervals, forming three spaced areas distributed at intervals. The three connecting ribs 317 of the latching main body 31 are inserted into the three spaced areas defined by the four second ribs 23, and are rotatably connected to the four second ribs 23 via the second pin 342. An axis where the second pin 342 is located is an axis about which the latching main body 31 is rotated relative to the lid 20, that is, the axis where the second pin 342 is located is a first axis L1.

As shown in FIG. 1, inner side walls of the two outermost second ribs 23 of the four second ribs 23 on the lid 20 are respectively flush with the inner side walls 311 of the two first ribs 133 on the case body 10 in a vertical direction. The left and right side walls of the latching main body 31 respectively attach to the opposing two inner side walls of the two first ribs 133 on the case body 10 and inner side walls of the two outermost second ribs 23 on the case body 10. Thus, a smoother rotation of the latching main body 31 about the second pin 342 is ensured.

In order to save materials, each latching main body 31 has a grid-like reinforcing rib 315 at a middle area of the inner side wall 311 of the latching main body 31. When the latching main body 31 is in a locking state, the reinforcing rib 315 on the inner side wall 311 of the latching main body 31 rests on a front side wall of the flange 130 on the case body 10. Each latching main body 31 has a first lock part 314 at an end (that is, an operating part 3102 of the latching main body 31) of the inner side wall 311 of the latching main body 31 away from the second pin 342. Each first lock part 314 extends from a side surface of the latching main body 31 to the locking engagement part 130. The two first lock parts 314 are symmetrically arranged in a lateral direction. When the latching main body 31 is rotated downward to be in a first locking state, a top portion of each first lock part 314 resists against the bottom of the flange 130. Preferably, a surface 3140 of the first lock part 314 of each latching main body 31 that is, the flange 130 which latches to the first part 130a of the locking engagement part 130 is a plane. Specifically, when the latching main body 31 is in the first locking state, the surface 3140 of the first lock part 314 of the latching main body 31 extends horizontally. Since the first part 130a of the flange 130 which latches to the surface 3140 at the top of the first lock part 314 of the latching main body 31 is a plane extending horizontally, when the latching main body 31 is in a first locking state, each first lock part 314 latches to the first part 130a of the flange 130 only along a vertical direction. The friction between the latching main body 31 and the flange 130 is relatively small during the locking or unlocking process, so that the latching main body 31 can be easily locked or unlocked by rotating from a locking state.

A recess 316 for accommodating the auxiliary latching unit 32 is defined between the two first lock parts 314. Herein, the dimension of the recess 316 in a lateral direction is substantially consistent with the dimension of the auxiliary latching member 32 in a lateral direction. The auxiliary latching unit 32 is rotatably connected to the two opposite side walls of the two first lock parts 314 on the latching main body 31 via a first pin 341 extending laterally. Specifically, the auxiliary latching unit 32 has a laterally penetrating first shaft hole 325 at a middle region of the auxiliary latching unit 32 in the vertical direction. The aforementioned first pin 341 runs across the first shaft hole 325 of the auxiliary latching unit 32, and left and right ends of the first pin 341 respectively extend beyond left and right side walls of the auxiliary latching unit 32 to connect to the two first lock parts 314 on the latching main body 31. An axis where the first pin 341 is located serves as a second axis L2 about which the auxiliary latching unit 32 rotates relative to the latching main body 31.

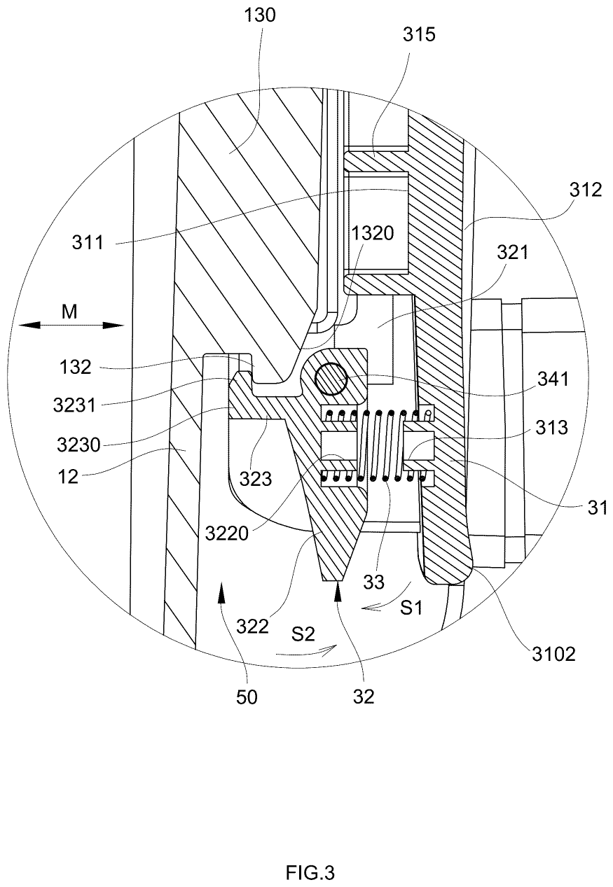

The auxiliary latching unit 32 comprises a limit stop 321 and a trigger portion 322 which extend in opposite directions from a portion where the second axis L2 located of the auxiliary latching unit 32. Specifically, taking the latching main body 31 in the first locking state as an example, the auxiliary latching unit 32 mounted on the latching main body 31 extends vertically as a whole. Herein, the limit stop 321 of the auxiliary latching unit 32 extends upward from the portion where the second axis L2 located of the auxiliary latching unit 32, and the trigger portion 322 extends downward from the portion where the second axis L2 located of the auxiliary latching unit 32. The elastic member 33 in this embodiment is a spring and the spring resists between the trigger portion 322 of the auxiliary latching unit 32 and the inner side wall 311 of the latching main body 31, urging the auxiliary latching unit 32 to rotate towards the locking engagement part 130 along a S1-direction as shown in FIG. 3. Meanwhile, the limit stop 321 of the auxiliary latching unit 32 resists against the inner side wall 311 of the latching main body 31 to limit a rotation angle of the auxiliary latching unit 32 away from the latching main body 31. To firmly fix the spring between the auxiliary latching unit 32 and the latching main body 31, a first position column 313 is disposed on the inner side wall 311 of the latching main body 31, a second position column 3220 is disposed on a side wall of the trigger portion 322 of the auxiliary latching unit 32 facing toward the latching main body 31. Two ends of the spring are respectively sleeved on the first position column 313 and the second position column 3220.

As shown in FIG. 3, the auxiliary latching unit 32 is disposed at a back of the latching main body 31 and is substantially invisible seen from the front of the case 1 under the cover of the latching main body 31. When the latching main body 31 is in the first locking state, an operating space 50 having a bottom opening is defined between the operating part 3102 of the latching main body 31 and a part of the first side wall 12 of the case body 10 corresponding to the flange 130. In this way, the operator's finger is allowed to reach upward into the operating space 50 from the bottom opening of the latching main body 31, and to press the trigger portion 322 of the auxiliary latching unit 32 for unlocking the auxiliary latching unit 32 to the flange 130.

To prevent the limit stop 321 of the auxiliary latching unit 32 from interfering with the reinforcing rib 315 on the inner side wall 311 of the latching main body 31—which would otherwise restrict a maximum rotation angle of the auxiliary latching unit 32—the limit stop 321 of the auxiliary latching unit 32 in this embodiment is specifically designed as two supporting arms spaced apart laterally. The two supporting arms respectively resist against recessed areas 3150 which are symmetrically distributed at left and right sides of the reinforcing rib 315 of the latching main body 31.

The auxiliary latching unit 32 has a second lock part 323 extending from the portion where the second axis L2 located of the auxiliary latching unit 32 to the first stopper 132 of the locking engagement part 130 on the case body 10. The second lock part 323 has a second stopper 3231 extending upward at an end of the second lock part 323 away from the auxiliary latching unit 32. A hook-shaped part 3230 with a hook-shaped cross section is connected to the second stopper 3231 of the auxiliary latching unit 32. When the auxiliary latching unit 32 deflects with the latching main body 31 for locking, the hook-shaped part 3230 of the auxiliary latching unit 32 resists against the first stopper 132 of the flange 130 and slightly deflects along the S2-direction as shown in FIG. 3 to press the spring under the guidance of a guiding slope 1320 of the first stopper 132. Then, the hook-shaped part 3230 moves past the first stopper 132 and resets, resting on a rear side of the first stopper 132. In this way, the auxiliary latching unit 32 and the first stopper 132 of the flange 130 are restricted from relative movement in a lateral direction (that is, the first direction-M), preventing the latching mechanism 30 from being deflected to open by outward pulling.

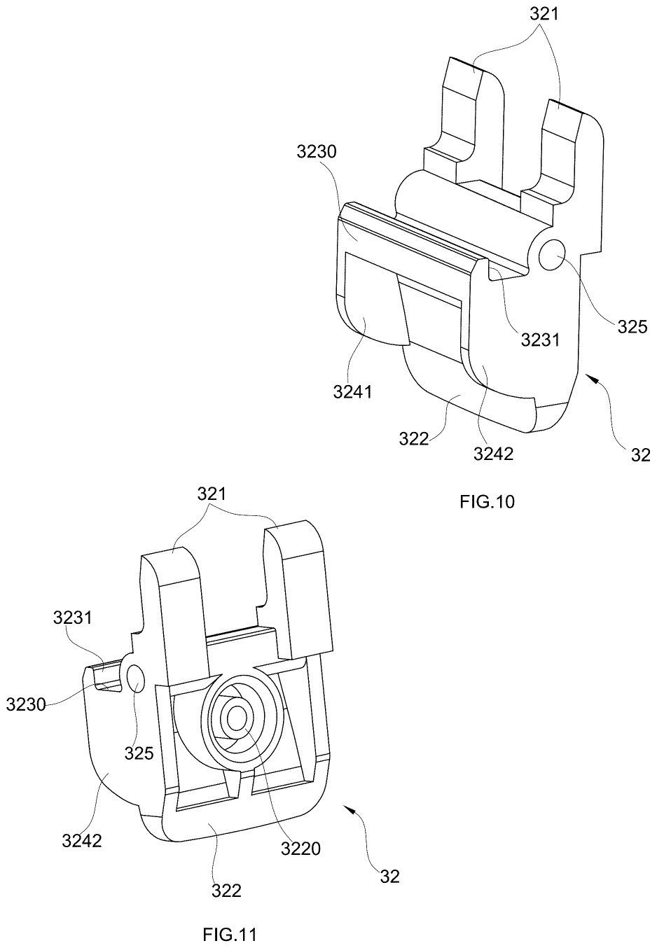

As shown in FIGS. 10-11, a first support rib 3241 and a second support rib 3242 which both extend toward the locking engagement part 130 are disposed on left and right sides of the trigger portion 322 of the auxiliary latching unit 32. Top portions of the first support rib 3241 and the second support rib 3242 are respectively connected to left and right sides of the second lock part 323 of the auxiliary latching unit 32. Thus, a structural strength of the auxiliary latching unit 32 is ensured and the damage of the second lock part 323 of the auxiliary latching unit 32 caused by excessive force is prevented.

The locking and unlocking operations of the latching mechanism 30 in this embodiment are described as follows:
the case body 10 is covered on the lid 20 firstly, then the latching main body 31 and the auxiliary latching unit 32 of each latching mechanism 30 are deflected downward, the first lock part 314 of each latching main body 31 latches to the corresponding first part 130a at the bottom of the flange body 131 of the case body 10. In this way, the two first lock parts 314 are restricted from movement relative to the flange body 131 in a vertical direction. Since the top portion of each first lock part 314 and the bottom of each flange body 131 are both planes, the friction between the latching main body 31 and the flange body 131 is relatively small, requiring small force for the latching main body 31 to be locked.

During the locking operation of the latching main body 31, a rear end of the hook-shaped part 3230 of the auxiliary latching unit 32 resists against the first stopper 132 on the flange 130 and slightly deflects along the S2-direction as shown in FIG. 3 to press the spring 33 under the guidance of the guiding slope 1320 of the first stopper 132. Then, the hook-shaped part 3230 moves past the first stopper 132 and resets, resting on a rear side of the first stopper 132. In this way, the auxiliary latching unit 32 is restricted from relative movement to the first stopper 132 in a lateral direction. Limited in both a vertical and lateral direction, the latching mechanism 30 cannot be easily deflected accidentally (for example, deflecting relative to the flange 130 due to unintended contact, etc.). Particularly, the auxiliary latching unit 32 is disposed at the back of the latching main body 31, which means the auxiliary latching unit 32 is hidden at an inner side of the latching main body 31, preventing unintended unlocking by accidental contact or pressure from external objects during handling or transportation. This significantly reduces the risk of the case being opened due to accidental triggering of the auxiliary latching unit 32.

When it is necessary to unlock the latching mechanism 30, the operating space 50 is defined between the latching main body 31 and the first side wall 12 of the case body 10, allowing the operator's finger to reach into the operating space 50 and operate the trigger portion 322 for unlocking the auxiliary latching unit 32 to the locking engagement part 130. The operator's finger is allowed to directly reach into the operating space 50 from the bottom of the latching main body 31 and operate the auxiliary latching unit 32 to make it detach from the first stopper 132 on the flange 130, so that the auxiliary latching unit 32 did not latch to the flange 130 in a front-to-rear direction. Then, the latching main body 31 is pulled forward to be deflected outward easily for detaching from the latching engagement part 130. In this way, the entire latching mechanism 30 detaches from the latching engagement part 130. A more labor-saving unlocking operation is ensured, which aligns with users' unlocking habits, providing a better user experience.

The latching mechanism 30 in this embodiment is not limited to latching the case body 10 to the lid 20 for a case. It can be thought that the two stacked cases can also be connected by the above-stated latching mechanism 30. Specifically, the latching mechanism 30 is disposed on one case and the corresponding locking engagement part 130 is arranged on the other case.

1. A latching mechanism for a case, being used to lock with a locking engagement part (130) connected to the case, comprising:
a latching main body (31) being rotatably connected to a sidewall of the case (1) around a first axis (L1) extending in a horizontal direction;
an auxiliary latching unit (32) connected to the latching main body (31) and being rotatable with the latching main body (31) relative to the case (1);
wherein,
in the process of the latching main body (31) rotating relative to the case (1) and the change of position of the latching main body (31) relative to the case (1), the latching main body (31) has at least a first locking state when locked to the locking engagement part (130), and a first unlocking state when separated from the locking engagement part (130);
when the latching main body (31) is in the first locking state, the auxiliary latching unit (32) locks to the locking engagement part (130), the auxiliary latching unit (32) has a trigger portion (322) which is capable of driving the auxiliary latching unit (32) to detach from the locking engagement part (130) under an external force;
the auxiliary latching unit (32) is disposed at a back of the latching main body (31) and is invisible seen from the front of the case (1) under the cover of the latching main body (31);
when the latching main body (31) is in the first locking state, an operating space (50) is defined on the latching main body (31) or between the latching main body (31) and the component which has the locking engagement part (130), the operating space (50) allows an operator's finger to reach into the operating space (50) and operate the trigger portion (322) for unlocking the auxiliary latching unit (32) from the locking engagement part (130).

2. The latching mechanism of claim 1, wherein the latching main body (31) has a connecting portion (3101) being connected to the case (1), and an operating part (3102) being located at an end of the latching main body (31) away from the connecting portion (3101);
when the latching main body (31) is in the first locking state, the operating space (50) is defined between the operating part (3102) of the latching main body (31) and the component which has the locking engagement part (130), and at least a part of the auxiliary latching unit (32) is located in the operating space (50).

3. The latching mechanism of claim 2, wherein the entire auxiliary latching unit (32) is located in the operating space (50).

4. The latching mechanism of claim 2, wherein the auxiliary latching unit (32) is rotatably connected to the latching main body (31) around a second axis (L2) which is parallel to the first axis (L1);
when changing positions in a rotation relative to the latching main body (31), the auxiliary latching unit (32) is in a second locking state when locking the locking engagement part (130) or in a second unlocking state when detachably unlocking the locking engagement part (130).

5. The latching mechanism of claim 4, wherein the auxiliary latching unit (32) comprises the trigger portion (322) extending from a portion where the second axis (L2) located of the auxiliary latching unit (32) towards the operating part (3102) of the latching main body (31) and a limit stop (321) extending from the portion where the second axis (L2) located of the auxiliary latching unit (32) towards the connecting portion (3101) of the latching main body (31);
when being subjected to an external force, the trigger portion (322) is moved towards the latching main body (31) so that the trigger portion (322) unlocks the locking engagement part (130).

6. The latching mechanism of claim 5, further comprising an elastic member (33) acting on the auxiliary latching unit (32);
wherein the elastic member (33) urges the trigger portion (322) of the auxiliary latching unit (32) away from the latching main body (31);
the limit stop (321) of the auxiliary latching unit (32) is capable of resisting against an inner side wall (311) of the latching main body (31) to make the movement of the trigger portion (322) of the auxiliary latching unit (32) in a certain range.

7. The latching mechanism of claim 6, wherein a side wall of the latching main body (31) in the first locking state facing the locking engagement part (130) of the case (1) is defined as the inner side wall (311) of the latching main body (31);
the elastic member (33) is a spring and the spring resists between the trigger portion (322) of the auxiliary latching unit (32) and the inner side wall (311) of the latching main body (31).

8. The latching mechanism of claim 7, wherein the spring has a first end and a second end, the first end of the spring is sleeved onto a first position column (313), the first position column (313) is disposed on the inner side wall (311) of the latching main body (31), the trigger portion (322) has a side wall facing the inner side wall (311) of the latching main body (31), a second position column (3220) is disposed on the side wall of the trigger portion (322) of the auxiliary latching unit (32) and the second end of the spring is sleeved on the second position column (3220).

9. The latching mechanism of claim 1, wherein the locking engagement part (130) comprises a first part (130a) with a horizontal surface and a second part (130b) with a vertical surface, the first part (130a) and the second part (130b) are arranged adjacent to each other;
the latching main body (31) has a side surface facing the locking engagement part (130), a first lock part (314) extending from the side surface of the latching main body (31) to the locking engagement part (130) latches to the first part (130a) of the locking engagement part (130) to limit the first part (130a) along a vertical direction, the auxiliary latching unit (32) has a side surface facing the locking engagement part (130), a second lock part (323) extending from the side surface of the auxiliary latching unit (32) to the locking engagement part (130) latches to the second part (130b) of the locking engagement part (130) to limit the second part (130b) along a front to rear direction.

10. The latching mechanism of claim 9, wherein at least a surface (3140) of the first lock part (314) of the latching main body (31) which latches to the first part (130a) of the locking engagement part (130) is a plane;
when the latching main body (31) is in the first locking state, the surface (3140) of the first lock part (314) of the latching main body (31) extends horizontally;
the second lock part (323) of the auxiliary latching unit (32) has an end away from the auxiliary latching unit (32), at least the end of the second lock part (323) is constructed with a hook-shaped part (3230) with a hook-shaped cross section;
when the auxiliary latching unit (32) latches to the locking engagement part (130) along with a rotation of the latching main body (31), the hook-shaped part (3230) of the auxiliary latching unit (32) passes a bottom of the second part (130b) of the locking engagement part (130) to rest in a side of the second part (130b) of the locking engagement part (130) away from the latching main body (31), so that the auxiliary latching unit (32) is locked in place to the locking engagement part (130).

11. The latching mechanism of claim 9, comprising two first lock parts (314) which are symmetrically arranged in a lateral direction, the auxiliary latching unit (32) is rotatably connected to two opposite sides of the two first lock parts (314), a recess (316) for accommodating the auxiliary latching unit (32) is defined between the two first lock parts (314).

12. The latching mechanism of claim 11, wherein the auxiliary latching unit (32) has a transverse hollow first shaft hole (325), the auxiliary latching unit (32) is rotatably connected to two opposite sides of the two first lock parts (314) by a first pin shaft (341) running through the first shaft hole (325).

13. The latching mechanism of claim 9, wherein a first support rib (3241) and a second support rib (3242) which both extend toward the locking engagement part (130) are disposed on the trigger portion (322) of the auxiliary latching unit (32), the first support rib (3241) and the second support rib (3242) are respectively connected to left and right sides of the second lock part (323) of the auxiliary latching unit (32).

14. The latching mechanism of claim 1, wherein a side wall of the latching main body (31) in the first locking state away from the locking engagement part (130) is defined as an outer side wall (312) of the latching main body (31), the outer side wall (312) of the latching main body (31) is constructed as a complete plane or curved structure.

15. A case, comprising a case body (10) having a top opening and a lid (20) which can be opened or closed is disposed on a top opening of the case body (10);
wherein,
the locking engagement part (130) is connected to one of the case body (10) or the lid (20), the latching mechanism (30) of claim 1 is connected to the other of the case body (10) and the lid (20);
when the lid (20) is closed on the top opening of the case body (10), the lid (20) is locked to the case body (10) by the latching mechanism (30) locking to the locking engagement part (130).

16. The case of claim 15, wherein the case body (10) comprises a bottom wall (11) and a first side wall (12) vertically extending upward from a periphery of the bottom wall (11), the case body (10) has a flange protruding from the first side wall (12) of the case body (10) to the outside, the flange comprises a flange body (131) and a first stopper (132) extending downward from a bottom of the flange body (131), a gap exists between the first stopper (132) and the first side wall (12) of the case body (10);
the lid (20) comprises a top wall (21) and a second side wall (22) vertically extending downward from a periphery of the top wall (21), the latching mechanism (30) is vertically disposed at the second side wall (22) of the lid (20) and opposite the flange at the first side wall (12) of the case body (10);
when the latching main body (31) of the latching mechanism (30) is in the first locking state, a part of the latching main body (31) is locked to the bottom of the flange body (131);
when the auxiliary latching unit (32) is locked, a part of the auxiliary latching unit (32) is limited at a side of the first stopper (132) facing towards the case body (10), the flange is defined as the locking engagement part (130).

17. The case of claim 16, wherein a part where the first stopper (132) of the flange is connected to the flange body (131) is located at a middle position of the flange body (131) in a lateral direction;
when in the first locking state, the latching main body (31) is locked to the bottom of the flange body (131) on left and right sides of the first stopper (132).

18. The case of claim 16, wherein the first stopper (132) of the flange has an outer side wall, at least a lower portion of the outer side wall is constructed as a guiding slope (1320) that vertically inclines downward towards an inside of the case body (10).

19. The case of claim 16, wherein two first ribs (133) each extending vertically and protruding outwardly are disposed at the first side wall (12) of the case body (10) corresponding to the left and right sides of the flange, the latching main body (31) in the first locking state is arranged between the two first ribs (133).

20. The case of claim 19, wherein left and right sides of the latching main body (31) respectively attach to opposite side walls of the two first ribs (133).

21. The case of claim 20, wherein the first side wall (12) of the case body (10) has a first edge (120) protruding outward relative to the first side wall (12) formed at a periphery of the top opening on the first side wall (12), the first edge (120) seals with a bottom periphery of the second side wall (22) of the lid (20), a top of the each first rib (133) of the case body (10) is connected to the first edge (120) of the case body (10).
